(19) United States
(12) Patent Application Publication
(10) Pub. No.: US 2022/0361450 A1
(43) Pub. Date: Nov. 17, 2022

(54) INTERACTIVE TUG TOY

(71) Applicant: WORLDWISE, INC., Novato, CA (US)

(72) Inventor: Allen Grainer, Denver, CO (US)

(21) Appl. No.: 17/741,140

(22) Filed: May 10, 2022

Related U.S. Application Data
(60) Provisional application No. 63/188,024, filed on May 13, 2021.

(51) Int. Cl. A01K 15/02

(52) U.S. Cl. CPC A01K 15/025

(57) ABSTRACT

A dog toy with a body and a plurality of actuatable elements is disclosed. Each of the actuatable elements is coupled to at least one other actuatable element. Movement of one actuatable element causes a corresponding movement of another actuatable element.

### CROSS REFERENCE TO RELATED APPLICATIONS

This application claims priority from and benefit of U.S. Provisional Patent Application Ser. No. 63/188,024, filed May 13, 2022, entitled “INTERACTIVE TUG TOY,” which is assigned to the assignee hereof, and is incorporated by reference in its entirety.

### TECHNICAL FIELD

The present invention involves a pet activity toy primarily intended for use by domestic dogs. The toy satisfies the need for a dog to bite and pull while interacting with a human or other dog.

### BACKGROUND OF THE INVENTION

Domesticated dogs, as most know, make ideal pets as they are generally friendly, loyal and can be trained to assume a number of tasks and are obedient. Many dogs, however, have the need to bite and pull, a tendency which begins as puppies but often times can continue well into adulthood. As a result, there have been a wide variety of toys sold in the marketplace to address these needs. A suitable toy should be durable and sufficiently attractive to the owner or the pet.

These and further objects will be more readily appreciated when considering the following description and figures.

### SUMMARY OF THE INVENTION

This disclosure includes an interactive dog toy having a body portion and a plurality of actuatable elements. Each of the actuatable elements may be coupled to at least one other actuatable element so that movement of one actuatable element causes a corresponding movement of another actuatable element. At least a portion of each element remains disposed within the body.

In one aspect, at least two of the actuatable elements may be a first continuous structure. The first continuous structure may be routed through an aperture in another of the actuatable elements. The aperture may be within a second continuous structure that comprises at least a different two actuatable elements.

In one aspect, one actuatable element may be coupled to at least two other actuatable elements.

In one aspect, exposing one actuatable element from the body causes another actuatable element to be retracted.

In one aspect, at least one actuatable element may be configured to retract entirely within the body.

In one aspect, at least one of the actuatable elements may be one of an arm, leg, tail, wing, fin, hand, foot, finger, mouth, neck and head.

This disclosure is also directed to a method for interacting with a dog. A toy having a body portion and a plurality of actuatable elements may be provided, such that each of the actuatable elements is coupled to at least one other actuatable element. One actuatable element may be engaged to cause a corresponding movement of another actuatable element, such that at least a portion of each element remains disposed within the body.

### BRIEF DESCRIPTION OF THE DRAWINGS

Further features and advantages will become apparent from the following and more particular description of the preferred embodiments of the disclosure, as illustrated in the accompanying drawings, and in which like referenced characters generally refer to the same parts or elements throughout the views, and in which:

FIG. 1 is an elevational view of an interactive dog toy configured as a chicken having actuatable elements according to an embodiment.

FIGS. 2a-c are schematic depictions of the movement of elements of FIG. 1 in response to actuation of other elements according to an embodiment.

FIG. 3 is a partial view of the toy of FIG. 1 showing internal components according to an embodiment.

FIGS. 4a-d are schematic depictions of the movement of actuatable elements of an interactive dog toy configured as a dragon according to an embodiment.

FIG. 5 is a side view of the toy of FIGS. 4a-d showing internal components according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings. These and similar directional terms should not be construed to limit the scope of the disclosure in any manner.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

As noted above, this disclosure is directed to interactive canine toys in the form of figural representations. Each toy includes a body portion in combination with a plurality of elements that further embody the representation by replicating various features of the representation. For example, the elements can be appendages, such as arms, legs, tails, wings, fins, hands, feet, fingers, toes, or the like, as well as other anatomical features of the representation, such as a mouth, hair or neck. Notably, two or more of the elements are coupled such that each actuate one or more of other elements of the plurality of elements. The elements are partially disposed within the body and can be retracted or exposed to change the outward appearance of the toy when a linked element is actuated. Further, a portion of each element remains accessible to the dog so that it can be engaged and pulled, typically by biting. It will also be appreciated that the elements can be actuated by another dog or a human during play. Specific examples of a chicken and a dragon are depicted below, but farm animals, frogs and other amphibians, fish, wild animals, dinosaurs, persons, aliens, or virtually any other figural representation can be used.

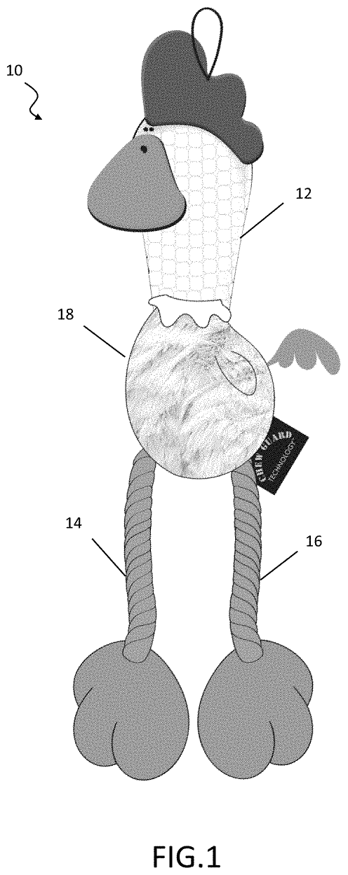

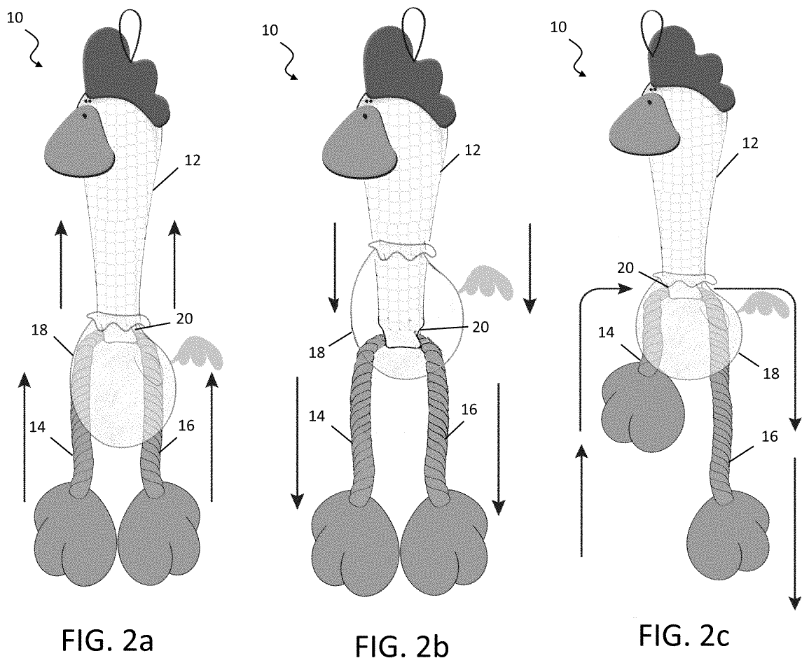

To help illustrate aspects of this disclosure, one embodiment of an interactive dog toy 10 is depicted in FIG. 1. As shown, this example is a figural representation of a cartoon chicken, with actuatable elements including a neck 12 and two legs 14 and 16 that generally extend from a body 18. According to the techniques of this disclosure, tugging or pulling on one element of the representation actuates movement of one or more other elements interactively so that the configuration of the representation changes dynamically in response to input from the dog or human. For example, FIGS. 2a-2c schematically demonstrate the coupling of these elements such that actuation of one causes movement of one or more different elements in response. Notably, body 18 is shown in phantom so that the interaction of the various elements can be shown. Generally, legs 14 and 16 are formed from a piece of rope or the like that extends through an aperture 20 in the neck element that remains inside boy 18. As such, tugging neck 12 upwards causes legs 14 and 16 to be retracted into body 18 as shown in FIG. 2a. Pulling legs 14 and 16 down likewise causes neck 12 to be retracted into body 18 as shown in the FIG. 2b. Further, pulling one of the legs, leg 16 as shown in FIG. 2c, causes it to extend, while the other leg, leg 14, is retracted, as the continuous member is pulled through neck aperture 20. The action can be reversed to retract the other leg.

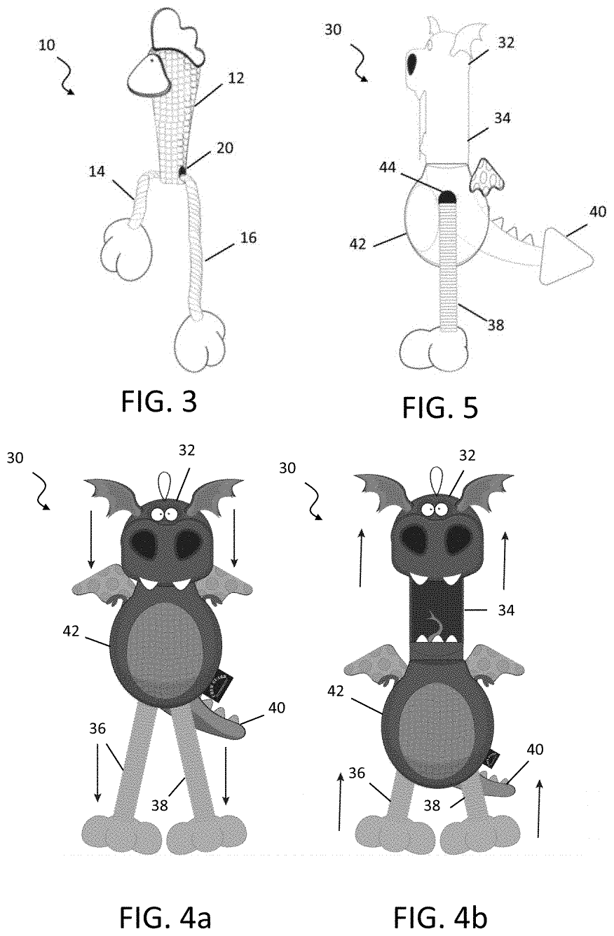

A detail view of neck 12 and legs 14 and 16 without the body is shown in FIG. 3. As will be appreciated, the neck construction can be configured to resist tearing, such as with cross-axial reinforcement as shown. Aperture 20 can also be reinforced to compensate for frictional wear.

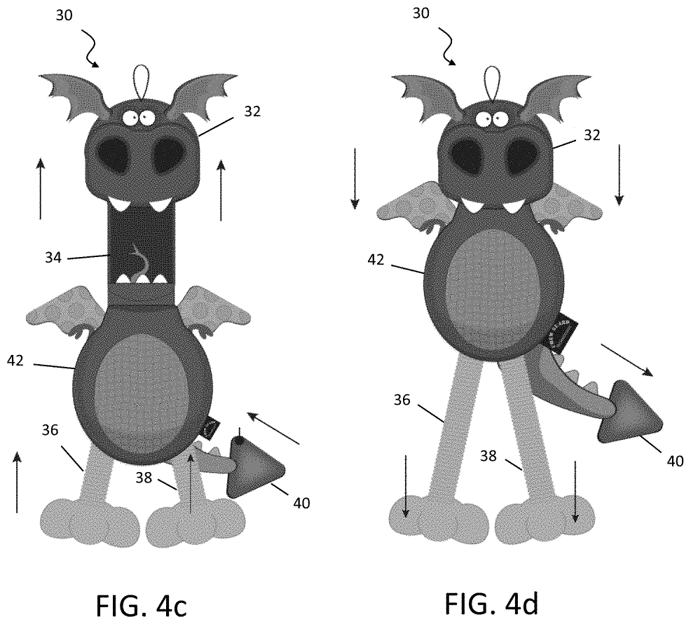

As another example, interactive toy 30 is illustrated in FIGS. 4a-4d, with the relative movement of the coupled elements schematically indicated. In this embodiment, toy 30 is configured as a dragon and has actuatable elements including a head 32 with an opening and closing mouth 34, legs 36 and 38 and tail 40, all of which extend from a body portion 42. In a similar manner to that described above, it will be appreciated that legs 36 and 38 can pass through an aperture (not shown in these views) formed in the element that constitutes mouth 34. When legs 36 and 38 are pulled down, as shown in FIG. 4a, the structure of mouth 34 is within body 42 and not visible. However, when head 32 is tugged up, mouth 34 slides from within body 42 and is now visible, and may include details such as the tongue and additional teeth as shown in FIG. 4b. As with the above embodiment, pulling one of legs 36 and 38 also retracts the other.

In the variation shown in FIGS. 4c and 4d, mouth 34 may extend through body 42 and be directly coupled with tail 40 as a continuous structure. Accordingly, tugging head 32 up exposes mouth as discussed above but also retracts tail 40 in this embodiment. Since legs 36 and 38 still travel through an aperture in mouth 34, when head 32 is tugged up, tail 40 as well as legs 36 and 38 retract into body 42, as shown in FIG. 4c. Correspondingly, pulling legs 36 and 38 will retract head 32 so that mouth 34 is contained in body 42 and no longer visible or conveys a closed configuration as shown in FIG. 4d. In this embodiment, the same effect can be achieved by tugging tail 40 to retract mouth 34. Independently, pulling one of legs 36 and 38 retracts the other in the manner described above.

Further details regarding this embodiment are shown in FIG. 5, a side view with body 42 partially in phantom. As shown, head 32, mouth 34 and tail 40 are a continuous structure that extends through body 42. Legs 36 and 38 slide through aperture 44 of mouth 34 and remains within body 42 whether open or closed. Notably, this drawing also shows that the lower portions of mouth 34 can be recessed with respect to the upper portions so that mouth 34 can be pulled smoothly into the body by either legs 36 and 38 or tail 40 as described above, while the upper portions help form a stop, limiting the range of motion when the mouth appears closed.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention.

What is claimed is:

1. An interactive dog toy comprising a body portion and a plurality of actuatable elements, wherein each of the actuatable elements is coupled to at least one other actuatable element so that movement of one actuatable element causes a corresponding movement of another actuatable element and wherein at least a portion of each element remains disposed within the body.

2. The interactive dog toy of claim 1, wherein at least two of the actuatable elements comprise a first continuous structure.

3. The interactive dog toy of claim 2, wherein the first continuous structure is routed through an aperture in another of the actuatable elements.

4. The interactive dog toy of claim 3, wherein the aperture is within a second continuous structure that comprises at least a different two actuatable elements.

5. The interactive dog toy of claim 1, wherein one actuatable element is coupled to at least two other actuatable elements.

6. The interactive dog toy of claim 1, wherein exposing one actuatable element from the body causes another actuatable element to be retracted.

7. The interactive dog toy of claim 1, wherein at least one actuatable element is configured to retract entirely within the body.

8. The interactive dog toy of claim 1, wherein at least one of the actuatable elements is one of an arm, leg, tail, wing, fin, hand, foot, finger, mouth, neck and head.

9. A method for interacting with a dog, comprising providing a toy having a body portion and a plurality of actuatable elements, wherein each of the actuatable elements is coupled to at least one other actuatable element and engaging one actuatable element to cause a corresponding movement of another actuatable element, wherein at least a portion of each element remains disposed within the body.
